(19) United States
(12) Patent Application Publication
(10) Pub. No.: US 2024/0381409 A1
(43) Pub. Date: Nov. 14, 2024

(54) METHOD AND APPARATUS FOR CONFIGURING PRIORITY OF SIDELINK POSITIONING REFERENCE SIGNAL IN WIRELESS COMMUNICATION SYSTEM

(71) Applicant: Samsung Electronics Co., Ltd., Suwon-si (KR)

(72) Inventors: Jeongseok YU, Suwon-si (KR); Hyunjeong KANG, Suwon-si (KR); Taeseop LEE, Suwon-si (KR)

(21) Appl. No.: 18/660,868

(22) Filed: May 10, 2024

(30) Foreign Application Priority Data
May 10, 2023 (KR) 10-2023-0060652

(51) Int. Cl. H04W 72/563; H04L 5/00; H04W 72/25

(52) U.S. Cl. CPC H04W 72/563; H04L 5/0051; H04W 72/25

(57) ABSTRACT

The disclosure relates to a fifth generation (5G) or sixth generation (6G) communication system for supporting a higher data transmission rate. A method performed by a transmitting terminal in a wireless communication system of the disclosure is provided. The method includes receiving a sidelink system information block (SIB) from a base station, requesting transmission resources to perform sidelink communication with a receiving terminal from the base station, receiving downlink control information (DCI) through a physical downlink control channel (PDCCH) from the base station, identifying sidelink scheduling information included in the DCI, and performing scheduling based on the sidelink scheduling information.

### CROSS-REFERENCE TO RELATED APPLICATION(S)

This application is based on and claims priority under 35 U.S.C. § 119 (a) of a Korean patent application number 10-2023-0060652, filed on May 10, 2023, in the Korean Intellectual Property Office, the disclosure of which is incorporated by reference herein in its entirety.

### BACKGROUND

### 1. Field

The disclosure relates to a wireless communication system and a mobile communication system. More particularly, the disclosure relates to a method and an apparatus for configuring a priority of a sidelink positioning reference signal in a wireless communication system.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as beyond 5G systems) in terahertz (TH2) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for configuring a priority of a sidelink positioning reference signal in a wireless communication system, thereby providing more efficient transmission and measurement of sidelink positioning reference signals used in sidelink positioning procedures, and more efficient selection and allocation of sidelink transmission resources.

Additional aspects will be set forth in part in the description which follows and, in part, will be apparent from the description, or may be learned by practice of the presented embodiments.

In accordance with an aspect of the disclosure, a method performed by a transmitting terminal in a wireless communication system is provided. The method includes receiving a sidelink system information block (SIB) from a base station, requesting transmission resources to perform sidelink communication with a receiving terminal from the base station, receiving downlink control information (DCI) from the base station through a physical downlink control channel (PDCCH), identifying sidelink scheduling information included in the DCI, and performing scheduling based on the sidelink scheduling information.

In accordance with another aspect of the disclosure, a predetermined terminal that wishes to perform sidelink positioning is provided. The predetermined terminal uses a priority of sidelink positioning reference signals to select and reselect resources through which the sidelink positioning reference signals are transmitted, based on a method of applying priorities indicated or transmitted by a corresponding terminal or base station, or another terminal in order to configure priorities for sidelink control information for scheduling sidelink positioning reference signals.

Other aspects, advantages, and salient features of the disclosure will become apparent to those skilled in the art from the following detailed description, which, taken in conjunction with the annexed drawings, discloses various embodiments of disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a next-generation mobile communication system according to an embodiment of the disclosure;

FIG. 2 illustrates a user plane radio protocol structure of a next-generation mobile communication system according to an embodiment of the disclosure;

FIG. 3 illustrates a control plane wireless protocol structure of a next-generation mobile communication system according to an embodiment of the disclosure;

FIG. 4 illustrates a structure of a base station in a wireless communication system according to an embodiment of the disclosure;

FIG. 5 illustrates a structure of a terminal in a wireless communication system according to an embodiment of the disclosure;

FIG. 6A illustrates scenarios for sidelink communication in a wireless communication system according to an embodiment of the disclosure;

FIG. 6B illustrates scenarios for sidelink communication in a wireless communication system according to an embodiment of the disclosure;

FIG. 6C illustrates scenarios for sidelink communication in a wireless communication system according to an embodiment of the disclosure;

FIG. 6D illustrates scenarios for sidelink communication in a wireless communication system according to an embodiment of the disclosure;

FIG. 7A illustrates a transmission method of sidelink communication in a wireless communication system according to an embodiment of the disclosure;

FIG. 7B illustrates a transmission method of sidelink communication in a wireless communication system according to an embodiment of the disclosure;

FIG. 8 illustrates a sidelink resource pool in a wireless communication system according to an embodiment of the disclosure;

FIG. 9 illustrates a signal flow of allocating sidelink transmission resources in a wireless communication system according to an embodiment of the disclosure;

FIG. 10 illustrates a signal flow of allocating sidelink transmission resources in a wireless communication system according to an embodiment of the disclosure;

FIG. 11 illustrates a channel structure of a slot used for sidelink communication in a wireless communication system according to an embodiment of the disclosure;

FIG. 12 illustrates a signal flow of configuring a priority of sidelink positioning reference signals in a wireless communication system according to an embodiment of the disclosure;

FIG. 13 illustrates a signal flow in which a base station indicates resources to be used for transmission of sidelink positioning reference signals in a wireless communication system according to an embodiment of the disclosure; and

FIG. 14 illustrates a signal flow of requesting a sidelink positioning reference signal from another terminal in a wireless communication system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments of the disclosure, descriptions related to technical contents well-known in the art to which the disclosure pertains and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the drawings, identical or corresponding elements are provided with identical reference numerals.

The advantages and features of the disclosure and ways to achieve them will be apparent by making reference to embodiments as described below in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined based on the functions in the disclosure, and may be different according to users, intentions of the users, or customs. Therefore, the definitions of the terms should be made based on the contents throughout the specification.

The following description of embodiments of the disclosure is mainly directed to new radio (NR) as a radio access network (RAN) and packet core 5G system or 5G Core network or next generation core (NG Core) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the following description, some of terms and names defined in the 3GPP standards (standards for 5G, NR, long term evolution (LTE), or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, the “unit” in the embodiments may include one or more processors.

The disclosure relates to a method and an apparatus for configuring a priority of a sidelink (hereinafter, SL) positioning reference signal in a wireless communication system. More specifically, the disclosure relates to a method and an apparatus for configuring priorities included in a sidelink positioning reference signal (hereinafter, SL-PRS) and sidelink control information (hereinafter, SCI) indicating resources for the SL-PRS, wherein the SL-PRS may be transmitted by at least two terminals that may be located in and/or out of base station communication range to perform sidelink positioning (hereinafter referred to as SL-POS) in a 3GPP 5G system.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

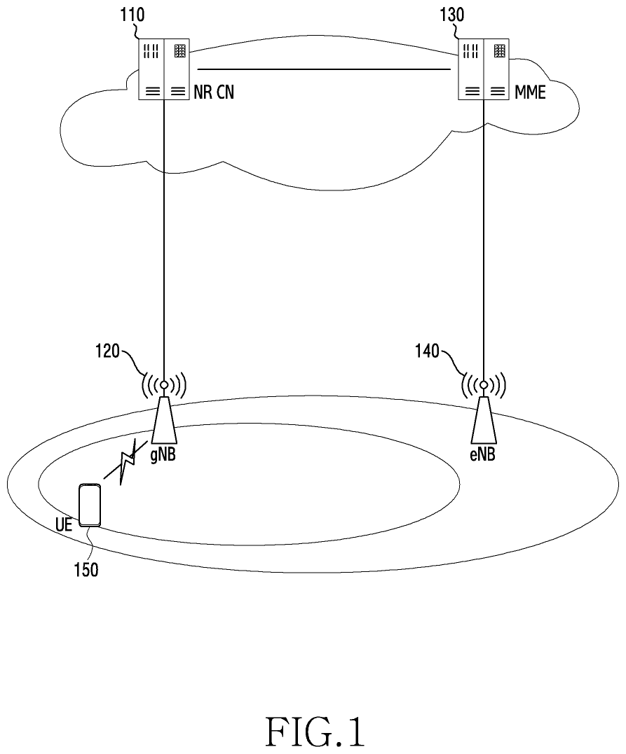

FIG. 1 illustrates a structure of a next-generation mobile communication system according to an embodiment of the disclosure.

Referring to FIG. 1, a radio access network of a next-generation mobile communication system (hereinafter NR or 5G) may include a next-generation base station (new radio node B, hereinafter NR gNB, gNB, or NR base station) 120, and a new radio core network (NR CN) 110. A user terminal (new radio user equipment, hereinafter NR UE or NR terminal) 150 may access an external network via the NR gNB 120 and the NR CN 110.

The NR gNB 120 may be connected to the NR UE 150 through a radio channel and provide outstanding services as compared to an eNB 140. In the next-generation mobile communication system, since all user traffic is serviced through a shared channel, a device that collects state information, such as buffer statuses, available transmit power states, and channel states of UEs, and performs scheduling accordingly is required, and the NR gNB 120 may serve as the device. In general, one NR gNB 120 may control multiple cells. In order to implement ultrahigh-speed data transfer beyond LTE, a wider bandwidth than the maximum bandwidth of LTE may be used, an orthogonal frequency division multiplexing (OFDM) scheme may be employed as a radio access technology (RAT), and a beamforming technology may be additionally integrated therewith. Furthermore, the next-generation mobile communication system may employ an adaptive modulation & coding (hereinafter referred to as AMC) scheme for determining a modulation scheme and a channel coding rate according to a channel state of a UE. The NR CN 110 may perform functions, such as mobility support and quality of service (QOS) configuration. The NR CN 110 is a device responsible for various control functions, as well as a mobility management function for a UE, and may be connected to multiple base stations. In addition, the next-generation mobile communication system may interwork with the LTE system, and the NR CN 110 may be connected to a mobility management entity (MME) 130 via a network interface. The MME 130 may be connected to the eNB 140.

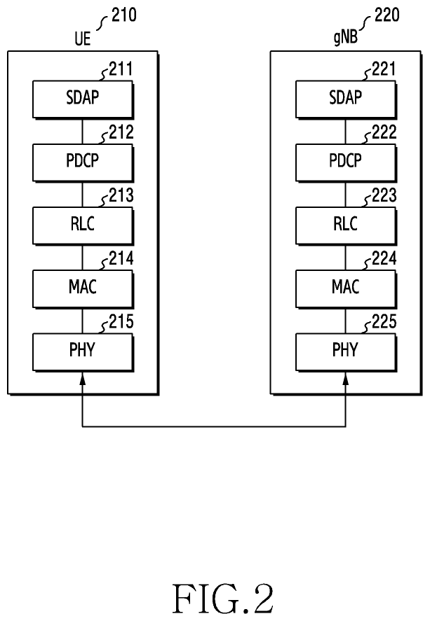

FIG. 2 illustrates a user plane radio protocol structure of a next-generation mobile communication system according to an embodiment of the disclosure.

Referring to FIG. 2, in a UE 210, a user plane radio protocol of a next-generation mobile communication system may consist of a service data adaptation protocol (SDAP) 211, a packet data convergence protocol (PDCP) 212, a radio link control (RLC) 213, a medium access control (MAC) 214, and/or a physical (PHY) 215. In a gNB 220, a user plane radio protocol of a next-generation mobile communication system may include an SDAP 221, a PDCP 222, an RLC 223, an MAC 224, and/or a PHY 225. In the disclosure, the expression “may consist of” may be replaced with the expression “may include”. For example, in a UE 210, a user plane radio protocol of a next-generation mobile communication system may include the SDAP 211, the PDCP 212, the RLC 213, the MAC 214, and/or the PHY 215.

Major functions of the SDAPs 211 and 221 may include at least some of the following functions. However, they are not limited thereto.
Mapping between a quality of service (QOS) flow and a data radio bearer
Marking QoS flow ID (QFI) in both DL and UL packets

Major functions of the PDCPs 212 and 222 may include some of the following functions. However, they are not limited thereto.
Transfer of data (user plane or control plane)
Maintenance of PDCP sequence numbers (SNs)
   Header compression and decompression using robust header compression (ROHC) protocol
   Header compression and decompression using ethernet header compression (EHC) protocol
   Compression and decompression of uplink PDCP service data units (SDUs): DEFLATE based uplink data compression (UDC) only
Ciphering and deciphering
Integrity protection and integrity verification)
Timer based SDU discard
Routing for split bearers
Duplication
Reordering and in-order delivery
Out-of-order delivery
Duplicate discarding

Major functions of the RLCs 213 and 223 may include some of the following functions. However, they are not limited thereto.
Transfer of upper layer protocol data units (PDUs)
Sequence numbering independent of the one in PDCP (unacknowledged mode (UM) and acknowledged mode (AM))
Error correction through automatic repeat request (ARQ) (AM only)
Segmentation (AM and UM) and re-segmentation (AM only) of RLC SDUs
Reassembly of SDU (AM and UM)
Duplicate detection (AM only)
RLC SDU discard (AM and UM)
RLC re-establishment
Protocol error detection (AM only)

Major functions of the MACs 214 and 224 may include at least some of the following functions. However, they are not limited thereto.
Mapping between logical channels and transport channels
Multiplexing of MAC SDUs from one or different logical channels onto transport blocks (TBs) to be delivered to physical layer on transport channels
Demultiplexing of MAC SDUs to one or different logical channels from transport blocks (TBs) delivered from physical layer on transport channels
Scheduling information reporting
Error correction through hybrid ARQ (HARQ)
Logical channel prioritization
Priority handling between overlapping resources of one UE

The PHY layers 215 and 225 may perform channel coding and modulation of upper layer data to generate OFDM symbols and may convert the OFDM symbols into a radio frequency (RF) signal and then transmit the same through an antenna. In addition, the PHY layers 215 and 225 may perform demodulation and channel decoding of the received OFDM symbols and then transfer the OFDM symbols to an upper layer.

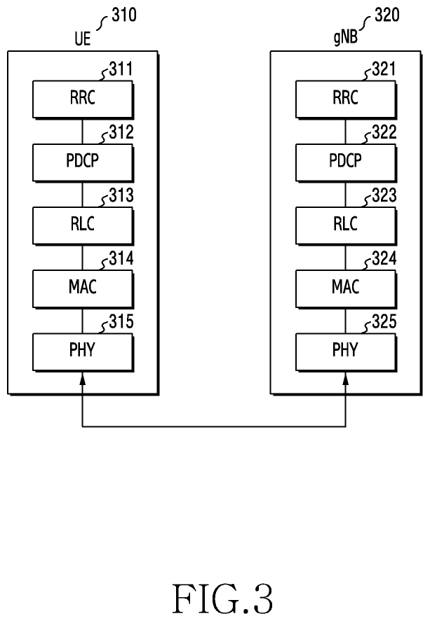

FIG. 3 illustrates a control plane radio protocol structure of a next generation mobile communication system according to an embodiment of the disclosure.

Referring to FIG. 3, in a UE 310, a control plane radio protocol of a next generation mobile communication system may include a radio resource control (RRC) 311, a PDCP 312, an RLC 313, a MAC 314, and/or a PHY 315. In a base station 320, the control plane radio protocol may include an RRC 321, a PDCP 322, an RLC 323, a MAC 324, and/or a PHY 325.

The functions of the RRCs 311, 321 may include at least some of the following functions.
Broadcast of system information related to access stratum (AS) and non access stratum (NAS)
paging initiated by 5G core (5GC) or NG-RAN
Establishment, maintenance, and release of an RRC connection between the UE and NG-RAN including: Addition, modification, and release of carrier aggregation; addition, modification, and release of Dual Connectivity in NR or between evolved universal mobile telecommunications system (UMTS) terrestrial radio access (E-UTRA) and NR
Security functions including key management
Establishment, configuration, maintenance and release of signaling radio bearers (SRBs) and data radio bearers (DRBs)
Mobility functions support (mobility functions including: handover and context transfer, UE cell selection and reselection and control of cell selection and reselection, inter-RAT mobility)
QoS management functions
UE measurement reporting and control of the reporting
Detection of and recovery from radio link failure
NAS message transfer to/from NAS from/to UE

The main functions of the PDCPs 312 and 322, RLCs 313 and 323, MACs 314 and 324, and/or PHY 315/325 may follow the example of FIG. 2.

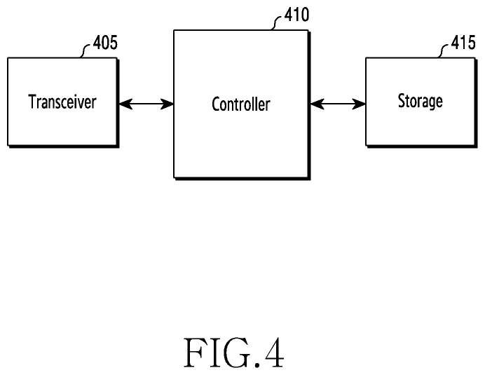

FIG. 4 illustrates a structure of a base station according to an embodiment of the disclosure.

Referring to FIG. 4, the base station may include a transceiver 405, a controller 410, and a storage 415. The transceiver 405, controller 410, and storage 415 may operate according to the communication method of the base station described above. Network devices may also correspond to the structure of the base station. However, the components of the base station are not limited to the above examples. For example, the base station may include more or fewer components than those described above. For example, the base station may include the transceiver 405 and the controller 410. In addition, the transceiver 405, controller 410, and storage 415 may be implemented in the form of a single chip.

The transceiver 405 is a term collectively referring to a receiver of the base station and a transmitter of the base station, and may transmit and receive signals to and from a UE, another base station, or other network devices. Here, the transmitted and received signals may include control information and data. For example, the transceiver 405 may transmit system information to the UE and may transmit a synchronization signal or a reference signal. To this end, the transceiver 405 may be configured by an RF transmitter that up-converts and amplifies the frequency of a transmitted signal, an RF receiver that low-noise amplifies a received signal and down-converts the frequency, and the like. However, this is only an example of the transceiver 405, and the components of the transceiver 405 are not limited to the RF transmitter and RF receiver. The transceiver 405 may include a wired or wireless transceiver and may include various components for transmitting and receiving signals. Additionally, the transceiver 405 may receive a signal through a communication channel (e.g., a wireless channel) and output the received signal to the controller 410, and transmit the signal output from the controller 410 through the communication channel. Additionally, the transceiver 405 may receive a communication signal, output the communication signal to a processor, and transmit the signal output from the processor to a UE, another base station, or another entity through a wired or wireless network.

The storage 415 may store programs and data necessary for the operation of the base station. Additionally, the storage 415 may store control information or data included in signals obtained from the base station. The storage 415 may be configured by a storage medium, such as read only memories (ROMs), random access memories (RAMs), hard disks, compact disc (CD)-ROMs, and digital versatile discs (DVDs), or a combination of storage media. In addition, the storage 415 may store at least one of information transmitted and received through the transceiver 405 and information generated through the controller 410.

In the disclosure, the controller 410 may be defined as a circuit, an application-specific integrated circuit, or at least one processor. The processor may include a communication processor (CP) that performs control for communication and an application processor (AP) that controls higher layers, such as application programs. The controller 410 may control the overall operation of the base station according to the embodiment proposed in this disclosure. For example, the controller 410 may control signal flow between respective blocks to perform operations according to the flowchart described above.

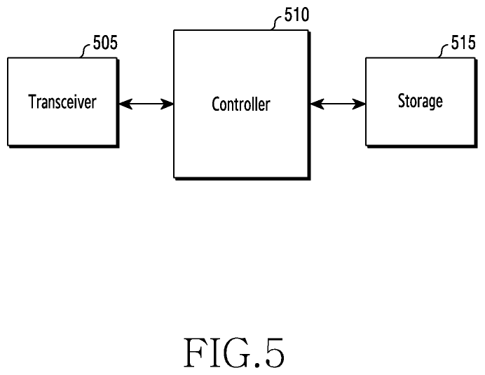

FIG. 5 illustrates a structure of a UE according to an embodiment of the disclosure.

Referring to FIG. 5, the UE may include a transceiver 505, a controller 510, and a storage 515. The transceiver 505, the controller 510, and the storage 515 may operate according to the communication method of the UE described above. However, the components of the UE are not limited to the examples described above. For example, the UE may include more or fewer components than the aforementioned components. For example, the UE may include the transceiver 505 and the controller 510. In addition, the transceiver 505, the controller 510, and the storage 515 may be implemented in the form of a single chip.

The transceiver 505 is a term collectively referring to a UE receiver and a UE transmitter, and may transmit and receive signals to and from a base station, another UE, or network entity. Signals transmitted and received to and from the base station may include control information and data. For example, the transceiver 505 may receive system information from a base station and may receive a synchronization signal or a reference signal. To this end, the transceiver 505 may be configured by an RF transmitter that up-converts and amplifies the frequency of a transmitted signal, and an RF receiver that low-noise amplifies a received signal and down-converts the frequency. However, this is only an example of the transceiver 505, and the components of the transceiver 505 are not limited to the RF transmitter and RF receiver. Additionally, the transceiver 505 may include a wired or wireless transceiver and may include various components for transmitting and receiving signals. Additionally, the transceiver 505 may receive a signal through a wireless channel and output the received signal to the controller 510, and transmit the signal output from the controller 510 through a wireless channel. Additionally, the transceiver 505 may receive a communication signal, output the communication signal to a processor, and transmit the signal output from the processor to a network entity through a wired or wireless network.

The storage 515 may store programs and data necessary for operation of the UE. Additionally, the storage 515 may store control information or data included in signals obtained from the UE. The storage 515 may be configured by a storage medium, such as ROMs, RAMs, hard disks, CD-ROMs, and DVDs, or a combination of storage media.

In the disclosure, the controller 510 may be defined as a circuit, an application-specific integrated circuit, or at least one processor. The processor may include a communication processor (CP) that performs control for communication and an application processor (AP) that controls higher layers, such as application programs. The controller 510 may control the overall operation of the UE according to the embodiment proposed in this disclosure. For example, the controller 510 may control signal flow between respective blocks to perform operations according to the flowchart described above.

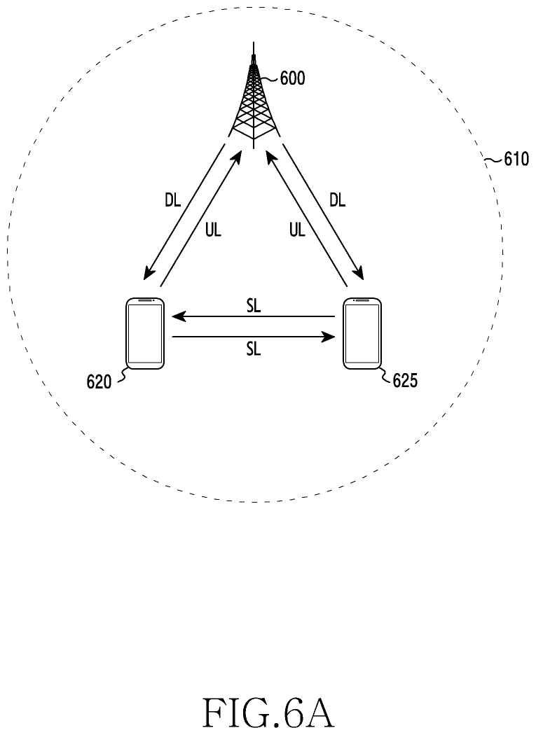

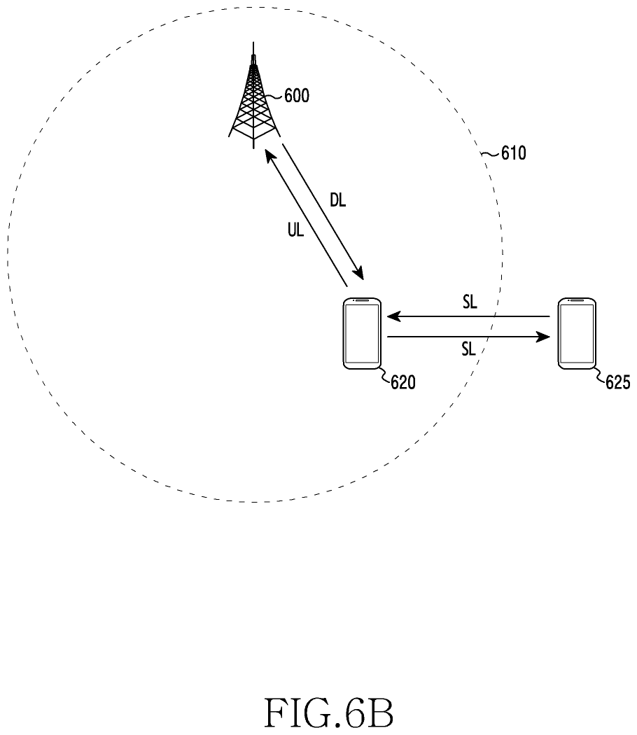

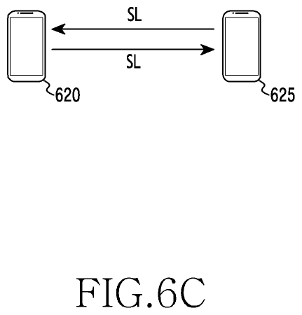

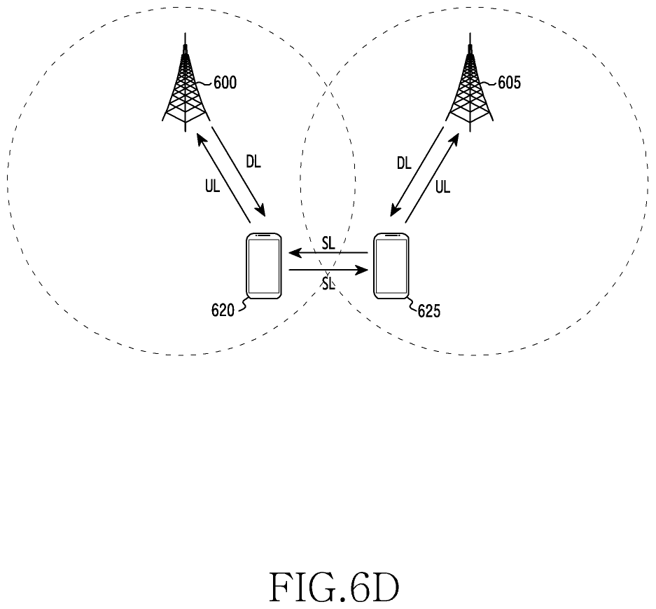

FIG. 6A illustrates scenarios for sidelink communication in a wireless communication system according to an embodiment of the disclosure.

Specifically, FIG. 6A illustrates an in-coverage (IC) scenario in which sidelink terminals (i.e., a first terminal 620 and a second terminal 625) are located within a coverage 610 of a base station 600.

Referring to FIG. 6A, the sidelink terminals (i.e., the first terminal 620 and the second terminal 625) may receive data and control information from the base station 600 through a downlink (DL), or may transmit data and control information to the base station 600 through an uplink (UL). In this case, the data and control information may be data and control information for sidelink (SL) communication or data and control information for general cellular communication other than sidelink communication. In addition, the sidelink terminals (i.e., the first terminal 620 and the second terminal 625) may transmit and receive data and control information for sidelink communication through the sidelink.

FIG. 6B illustrates scenarios for sidelink communication in a wireless communication system according to an embodiment of the disclosure.

Specifically, FIG. 6B illustrates a partial coverage (PC) scenario in which the first terminal 620 among sidelink terminals is located within the coverage 610 of the base station 600 and the second terminal 625 is located out of the coverage 610 of the base station 600.

Referring to FIG. 6B, the first terminal 620, located within the coverage 610 of the base station 600, may receive data and control information from the base station 600 through a downlink or may transmit data and control information to the base station 600 through an uplink. The second terminal 625, located out of the coverage of the base station 600, is unable to directly receive data and control information from the base station 600 through downlink, and is unable to directly transmit data and control information to the base station 600 through an uplink. The second terminal 625 may transmit and receive data and control information for sidelink communication through the sidelink with the first terminal 620.

FIG. 6C illustrates scenarios for sidelink communication in a wireless communication system according to an embodiment of the disclosure.

Specifically, FIG. 6C illustrates an out-of-coverage (OOC) scenario in which sidelink terminals (e.g., the first terminal 620 and the second terminal 625) are located out of the coverage 610 of the base station 600.

Referring to FIG. 6C, the first terminal 620 and the second terminal 625 are unable to receive data or control information from the base station 600 through downlink, and are unable to transmit data or control information to the base station 600 through an uplink. The first terminal 620 and the second terminal 625 may transmit and receive data and control information for sidelink communication through a sidelink.

FIG. 6D illustrates scenarios for sidelink communication in a wireless communication system according to an embodiment of the disclosure.

Referring to FIG. 6D, it illustrates a case in which the first terminal 620 and the second terminal 625 performing sidelink communication perform inter-cell sidelink communication when they are connected to different base stations (e.g., a first base station 600 and the second base station 605) or are camping (e.g., RRC disconnection state, that is, RRC idle or inactive state) thereon. In this case, referring to FIG. 6D, the first terminal 620 may be a sidelink transmission terminal, and the second terminal 625 may be a sidelink reception terminal. Alternatively, the first terminal 620 may be a sidelink reception terminal and the second terminal 625 may be a sidelink transmission terminal. The first terminal 620 may receive a sidelink-only system information block (SIB) from the first base station 600 to which the first terminal 620 is connected (or on which the first terminal 620 is camping), and the second terminal 625 may receive a sidelink-only SIB from another second base station 605 to which the second terminal 625 is connected (or on which the second terminal 625 is camping). In this case, the information of the sidelink-only SIB received by the first terminal 620 and the information of the sidelink-only SIB received by the second terminal 625 may be different from each other. Accordingly, in order to perform sidelink communication between terminals located in different cells, information may be unified, or an assumption and interpretation method thereof may additionally be required.

In the examples of FIGS. 6A, 6B, 6C, and 6D, for convenience of explanation, a sidelink system consisting of two terminals (e.g., the first terminal 620 and the second terminal 625) has been described as an example. However, the disclosure is not limited thereto, and may be applied to a sidelink system in which three or more terminals participate. Further, the uplink and downlink between the base station 600 and the sidelink terminals (i.e., the first terminal 620 and the second terminal 625) may be referred to as a Uu interface, and the sidelink between the sidelink terminals (i.e., the first terminal 620 and the second terminal 625) may be referred to as a PC5 interface. In addition, a sidelink terminal located out-of-coverage (OOC) in which a Uu interface is not connected to the base station 600 may receive data and control information from the base station indirectly via a relay of another sidelink terminal located in-coverage (IC) in which a Uu interface is connected to the base station 600. In the following description, the uplink or downlink and Uu interface may be interchangeably used, and sidelink and PC5 may be interchangeably used.

Meanwhile, in the disclosure, “terminal” may signify a vehicle supporting vehicle-to-vehicle (V2V) communication, a vehicle supporting vehicle-to-pedestrian (V2P) communication, a pedestrian's handset (e.g., smart phone), a vehicle supporting vehicle-to-network (V2N) communication, or a vehicle supporting vehicle-to-infrastructure (V2I) communication. In addition, in the disclosure, the terminal may signify a roadside unit (RSU) mounted with a terminal function, an RSU mounted with a base-station function, or an RSU mounted with part of a base-station function and part of a terminal function. In addition, the terminal may refer to a terminal that supports proximity service (hereinafter, ProSe) and SL-POS.

In addition, in the disclosure, the base station may be a base station supporting both sidelink and general cellular communication, or may be a base station supporting only sidelink. In this case, the base station may be a 5G base station (gNB), a 4G base station (eNB), or an RSU. Therefore, in the disclosure, the base station may be referred to as an RSU.

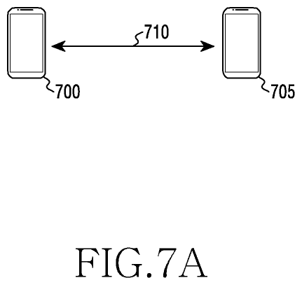

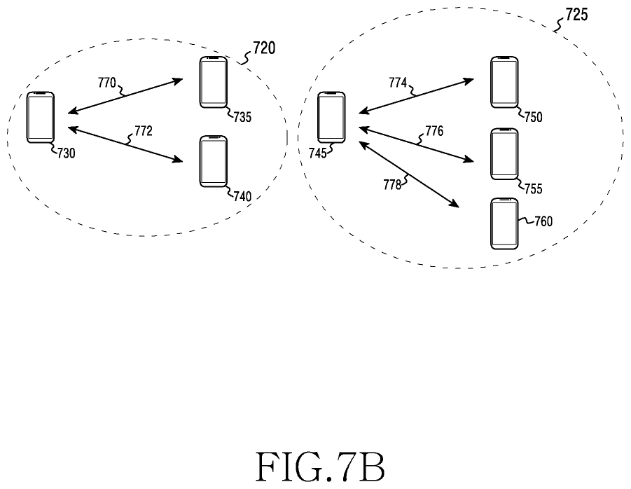

FIG. 7A illustrates a transmission method of sidelink communication in a wireless communication system according to an embodiment of the disclosure.

FIG. 7A illustrates a unicast method, and FIG. 7B illustrates a groupcast method.

Referring to FIG. 7A, a transmitting terminal 700 and a receiving terminal 705 may perform one-to-one communication 710. The transmission scheme shown in FIG. 7A may be referred to as unicast communication.

FIG. 7B illustrates a transmission method of sidelink communication in a wireless communication system according to an embodiment of the disclosure.

Referring to FIG. 7B, a transmitting terminal (e.g., a first terminal 730) and receiving terminals 735 and 740, or a transmitting terminal 745 and receiving terminals 750, 755, and 760 may perform one-to-many communication 770, 772, 774, 776, and 778, respectively. The transmission scheme shown in FIG. 7B may be referred to as groupcast or multicast transmission.

In FIG. 7B, the first terminal 730, a second terminal 735, and a third terminal 740 form one group to perform groupcast communication, while a fourth terminal 745, a fifth terminal 750, a sixth terminal 755, and a seventh terminal 760 may form another group to perform groupcast communication. The terminals may perform groupcast communication within the groups to which they belong, and may perform unicast, groupcast, or broadcast communication with at least one other terminal belonging to a different group. In FIG. 7B, two groups are illustrated, but the disclosure is not limited thereto, and may be applied even in the case in which a larger number of groups are formed.

Meanwhile, although not shown in FIG. 7A or 7B, sidelink terminals may perform broadcast communication. “Broadcast communication” refers to a method in which all sidelink terminals receive data and control information transmitted by a sidelink transmission terminal through a sidelink. For example, if the first terminal 730 in FIG. 7B is a transmitting terminal, the remaining terminals 735, 740, 745, 750, 755, and 760 may receive data and control information transmitted from the first terminal 730.

The aforementioned sidelink unicast communication, groupcast communication, and broadcast communication may be supported in an in-coverage scenario, a partial coverage scenario, or an out-of-coverage scenario.

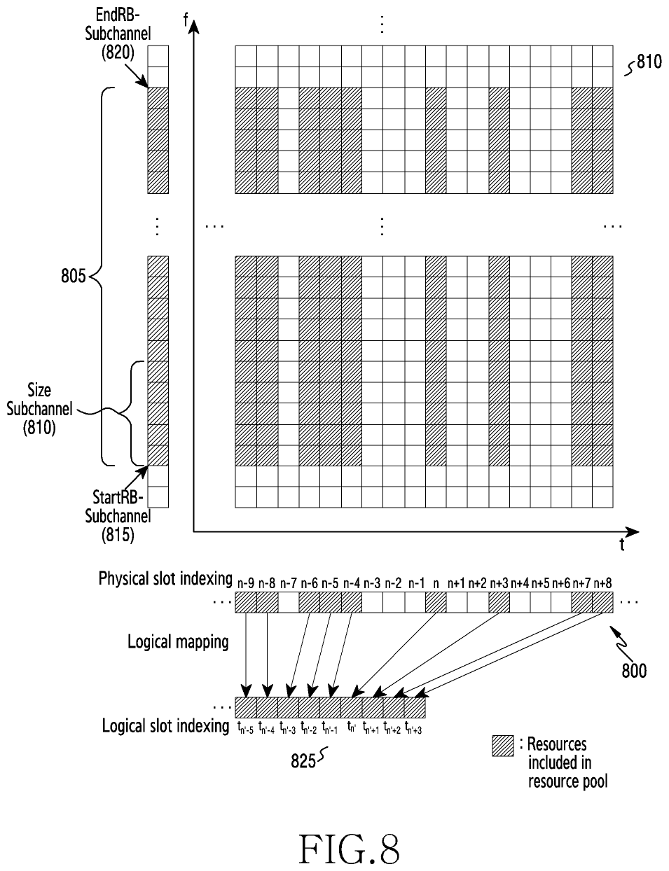

FIG. 8 illustrates a sidelink resource pool in a wireless communication system according to an embodiment of the disclosure.

A resource pool may be defined as a set of resources in a time and frequency domain used for transmission and reception of a sidelink.

In the resource pool, resource allocation granularity (resource allocation granularity) on the time axis may be one or more orthogonal frequency-division multiplexing (OFDM) symbols. In addition, the resource granularity on the frequency axis may be one or more physical resource blocks (PRBs).

When a resource pool is allocated in the time domain and the frequency domain, a region configured by shaded resources indicates a region configured as a resource pool in a time or frequency domain. In the disclosure, a case in which the resource pool is non-contiguously allocated in time will be described, but the disclosure is not limited thereto, and may also be applied when the resource pool is continuously allocated in time. In addition, although the case in which a resource pool is continuously allocated on a frequency domain will be described in the disclosure, the disclosure is not limited thereto, and may also be applied to the case where a resource pool is non-contiguously allocated in a frequency domain.

Referring to FIG. 8, a time domain 800 of the configured resource pool exemplifies the case in which resources are non-contiguously allocated in the time domain. In the time domain 800 of the resource pool, the granularity of resource allocation (resource granularity) on the time axis may be a slot. Specifically, one slot configured by 14 OFDM symbols may be a basic granularity of resource allocation on the time axis. Referring to the time domain 800 of the configured resource pool, shaded slots represent slots allocated to the resource pool in time, and slots allocated to the resource pool in time may be indicated using system information. For example, slots allocated to the resource pool in time may be indicated using the resource pool configuration information in time within the SIB. Specifically, at least one slot configured as a resource pool in time may be indicated through a bitmap. Referring to FIG. 8, physical slots 800 belonging to a non-contiguous resource pool on the time axis may be mapped to logical slots 825. In general, a set of slots belonging to a resource pool for a physical sidelink shared channel (PSSCH) may be expressed as (t0, t1, . . . , ti, . . . , tTmax).

Referring to FIG. 8, a frequency domain 805 of a configured resource pool exemplifies the case in which resources are continuously allocated in the frequency domain. In the frequency domain 805 of the resource pool, the granularity of resource allocation on the frequency axis may be a sub-channel 810. Specifically, one subchannel 810, configured by one or more resource blocks (RBs), may be defined as a basic granularity of resource allocation in a frequency domain. In addition, the subchannel 810 may be defined as an integer multiple of RBs. Referring to FIG. 8, a subchannel size (sizeSubchannel) may be configured by five consecutive PRBs, but the disclosure is not limited thereto, and the size of the subchannel may be configured differently. In addition, although one sub-channel is generally configured by consecutive PRBs, the sub-channel is not necessarily configured by consecutive PRBs. The subchannel 810 may be a basic granularity of resource allocation for PSSCH. In addition, a subchannel for a physical sidelink feedback channel (PSFCH) may be defined independently of the PSSCH.

Referring to FIG. 8, the start position of the subchannel 810 in a frequency domain in a resource pool may be indicated by startRB-Subchannel 815. When resource allocation is performed in units of subchannels 810 on the frequency axis, resource pool configuration in the frequency domain may be performed through an RB index (startRB-Subchannel) 815 at which the subchannel 810 starts, information for indicating how many RBs the subchannel is configured by (sizeSubchannel) 810, and configuration information for the total number of subchannels (numSubchannels). The resource pool configuration in the frequency domain may be performed through configuration information for an RB index at which the subchannel ends (EndRB-Subchannel) 820. According to various embodiments of the disclosure, the subchannels allocated to a resource pool in a frequency domain may be indicated using system information. For example, at least one of startRB-Subchannel, sizeSubchannel, EndRB-SubChannel, and numSubchannel may be indicated as frequency resource pool configuration information in the SIB. When the subchannel for the PSFCH is defined independently from the PSSCH, each of subchannel configuration information for the PSFCH and PSSCH may be indicated to the terminal.

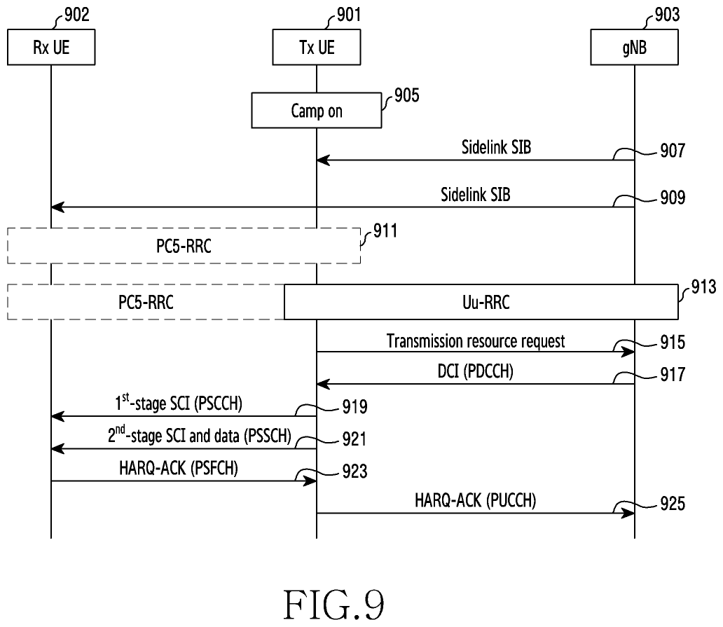

FIG. 9 illustrates a signal flow of allocating sidelink transmission resources in a wireless communication system according to an embodiment of the disclosure.

FIG. 9 illustrates signal exchange between a transmitting terminal 901, a receiving terminal 902, and a base station 903.

As described below, a scheme in which the base station allocates transmission resources for sidelink communication may be referred to as mode 1. Mode 1 is a scheme based on scheduled resource allocation by the base station. More specifically, in mode 1 resource allocation, the base station may allocate a resource used for sidelink transmission to the RRC-connected terminals and according to a dedicated scheduling scheme. Since the base station may manage the resources of the sidelink, scheduled resource allocation may be advantageous for interference management and resource pool management (e.g., dynamic allocation and/or semi-persistent transmission).

Referring to FIG. 9, the transmitting terminal 901 camping on (operation 905) may receive a sidelink SIB from the base station 903 in operation 907. In operation 909, the receiving terminal 902 may receive a sidelink SIB from the base station 903. Here, the receiving terminal 902 refers to a terminal that receives data transmitted by the transmitting terminal 901. The sidelink SIB may be transmitted periodically or according to request (on demand). In addition, the sidelink SIB may include at least one of sidelink resource pool information for sidelink communication, parameter configuration information for a sensing operation, information for configuring sidelink synchronization, or carrier information for sidelink communication operating at different frequencies. In the above, operations 907 and 909 have been described as being performed sequentially, but this is for convenience of explanation, and operations 907 and 909 may be performed in parallel.

In operation 913, when data traffic for sidelink communication is generated in the transmitting terminal 901, the transmitting terminal 901 may be RRC-connected with the base station 903. Here, the RRC connection between the transmitting terminal 901 and the base station 903 may be referred to as Uu-RRC. The Uu-RRC connection may be performed before the transmitting terminal 901 generates data traffic. In addition, in the case of mode 1, in a state in which a Uu-RRC connection is established between the base station 903 and the receiving terminal 902, the transmitting terminal 901 may perform transmission to the receiving terminal 902 through a sidelink. In addition, in the case of mode 1, the transmitting terminal 901 may perform transmission to the receiving terminal 902 through a sidelink even when the Uu-RRC connection is not established between the base station 903 and the receiving terminal 902.

In operation 915, the transmitting terminal 901 may request a transmission resource for performing sidelink communication with the receiving terminal 902 from the base station 903. Here, the transmitting terminal 901 may request transmission resources for the sidelink by using at least one of an uplink physical uplink control channel (PUCCH), an RRC message, or an MAC control element (CE) from the base station 903. For example, when MAC CE is used, the MAC CE may be MAC CE for a buffer status report (BSR) having a new format including at least one of an indicator for indicating that the buffer status report is for sidelink communication and information on the size of data stored in a buffer for device-to-device (D2D) communication (or V2X communication). These MAC CEs may be called sidelink BSR MAC CEs. In addition, when PUCCH is used, the transmitting terminal 901 may request a sidelink resource through a bit of a scheduling request (SR) transmitted through an uplink physical control channel. Furthermore, when RRC is used, the transmitting terminal 901 may transfer, to the base station via Uu-RRC, information of the receiving terminal 902 and the frequency for transmitting and receiving different kinds of sidelink communications including sidelink discovery, sidelink data communications, and sidelink relay communications, and at least one or more of the following information may be included through the same or different RRC messages.
Frequency to be used for reception in sidelink communication
Frequency to be used for transmission in sidelink communication
Types of sidelink data transmitted in sidelink communication
Period and size of sidelink data transmitted in sidelink communication
Information on the target terminal that receives sidelink data transmitted in sidelink communication (target terminal ID, terminal capability, discontinuous reception (DRX) information, or the like)
QoS information of sidelink data transmitted in sidelink communication
Cast type of sidelink data transmitted in sidelink communication
RLC mode of sidelink data transmitted in sidelink communication

In operation 915, the PUCCH, MAC CE, and RRC messages may be used independently of each other or may be used interchangeably depending on the purpose. In addition, operation 915 has been described after operation 913, but this is for convenience of explanation and may also be used by the transmitting terminal 901 to request resources for establishing a PC5-RRC 911 with the receiving terminal 902, and other operations, and may be performed in parallel or simultaneously with the other operations.

In operation 917, the base station 903 may transmit downlink control information (DCI) to the transmitting terminal 901 through PDCCH. In addition, the base station 903 may indicate, to the transmitting terminal 901, final scheduling for sidelink communication with the receiving terminal 902. More specifically, the base station 903 may allocate sidelink transmission resources to the transmitting terminal 901 according to at least one of a dynamic grant (DG) scheme or a configured grant (CG) scheme.

In the case of the dynamic grant (DG) scheme, the base station 903 may transmit the DCI to the transmitting terminal 901 to allocate resources for transmission of one transport block (TB). The sidelink scheduling information included in the DCI may include resource pool information, a parameter related to an initial transmission time and/or a retransmission time, and a parameter related to a frequency allocation location information field. DCI for the dynamic grant scheme may be scrambled by a cyclic redundancy check (CRC) based on a sidelink radio network temporary identifier (SL-RNTI) to indicate that the transmission resource allocation scheme is a dynamic grant scheme.

In the case of the configured grant scheme, by configuring a semi-persistent scheduling (SPS) interval in Uu-RRC, resources for transmitting a plurality of TBs may be periodically allocated. In this case, the base station 903 may allocate resources for a plurality of TBs by transmitting the DCI to the transmitting terminal 901. The sidelink scheduling information included in the DCI may include a parameter related to an initial transmission time and/or a retransmission time and a parameter related to a frequency allocation location information field. In the case of the configured grant scheme, an initial transmission time (occasion) and/or a retransmission time and a frequency allocation position may be determined according to the transmitted DCI, and the resource may be repeated at SPS intervals. The DCI for the configured grant scheme may be a CRC scrambled based on the sidelink configured scheduling radio network temporary identifier (SL-CS-RNTI) to indicate that the transmission resource allocation scheme is the configured grant scheme. In addition, the configured grant method may be classified into a type 1 CG and a type 2 CG. In the case of a type 2 CG, the base station 903 may activate and/or deactivate a resource configured by a configured grant through DCI. Accordingly, in the case of mode 1, the base station 903 may indicate, to the transmitting terminal 901, final scheduling for sidelink communication with the receiving terminal 902 by transmitting the DCI through the PDCCH.

When broadcast transmission is performed between the transmitting terminal 901 and the receiving terminal 902, the transmitting terminal 901 may broadcast SCI to the receiving terminal 902 through the physical sidelink control channel (PSCCH) without additional PC5-RRC configuration (operation 911) in operation 919. Further, in operation 921, the transmitting terminal 901 may broadcast data to the receiving terminal 902 through the PSSCH.

When a unicast or groupcast transmission is performed between the transmitting terminal 901 and the receiving terminal 902, the transmitting terminal 901 may perform a one-to-one RRC connection with other terminals (e.g., the receiving terminal 902) in operation 911. In this case, the RRC connection between the transmitting terminal 901 and the receiving terminal 902 may be referred to as PC5-RRC to distinguish the same from Uu-RRC. In the case of a groupcast transmission method, the PC5-RRC connection may be established separately between terminals within a group and between terminals. Referring to FIG. 9, the connection of the PC5-RRC (operation 911) is illustrated as an operation after the transmission of the sidelink SIB (operations 907 and 909), but the connection of the PC5-RRC (operation 911) may be performed prior to the transmission of the sidelink SIB or prior to the broadcast of the SCI (operation 919). If an RRC connection between the terminals is required, the PC5-RRC connection of the sidelink is performed, and in operation 919, the transmitting terminal 901 may transmit the SCI as a unicast or groupcast to the receiving terminal 902 via PSCCH. Here, a groupcast transmission of the SCI may be understood as a group SCI. Further, in operation 921, the transmitting terminal 901 may transmit data to the receiving terminal 902 as a unicast or groupcast via PSSCH. For mode 1, the transmitting terminal 901 may identify the sidelink scheduling information included in the DCI received from the base station 903, and may perform scheduling for the sidelink based on the sidelink scheduling information. The SCI may be divided into first-stage SCI transmitted to the PSCCH and second-stage SCI transmitted to the PSSCH, wherein the first-stage SCI may include at least one of the following information.
Priority
Frequency resource assignment
Time resource assignment
Resource reservation period
De-modulation reference signal (DMRS) pattern
2nd-stage SCI format
Beta_offset indicator
Number of DMRS port
Modulation and coding scheme (MCS)
Additional MCS table indicator
PSFCH overhead indication
Reserved
Conflict information receiver flag

Priority may be transmitted or configured at a higher layer, and the priority value may be designated using 3 bits as a value of up to 8, such as 000 for priority value 1 and 001 for priority value 2. In the case of sidelink data, this priority value may have the highest value among priorities of all logical channels or MAC CEs in the TB scheduled by the corresponding SCI. In the case of transmitting a MAC CE or SCI for inter-UE coordination, the priority value may have a value configured by the RRC parameter that is different from the priority of the corresponding MAC CE. If no RRC parameter is configured, an inter-UE coordination request MAC CE may have the highest value among the priorities of all logical channels or MAC CEs included in the TB to be transmitted to the UE receiving the MAC CE, and an inter-UE coordination information MAC CE transmitted by the UE having received the MAC CE to respond to the request may have the value which is the same as the value corresponding to the priority field in the inter-UE coordination request MAC CE. In addition, if the inter-UE coordination information MAC CE is transmitted by a specific condition (e.g., a case in which the reference signal received power (RSRP) of a resource reserved by a third terminal is higher than a specific value) rather than by a request from another terminal, the priority may be randomly selected by the terminal from a value from 1 to 8.

The reservation interval may be indicated as a single value with a fixed interval between TBs when resources for multiple TBs (i.e., multiple MAC protocol data units (PDUs)) are selected, or “0” may be indicated as the value of the interval between TBs when resources for a single TB are selected.

The 2nd-stage SCI may be included in the PSSCH resource indicated in the 1st-stage SCI transmitted in operation 919, and is transmitted with the data in operation 921. The second-stage SCI may include at least one of the following information.
HARQ process number
New data indicator
Redundancy version
Source ID
Destination ID
HARQ feedback enabled/disabled indicator
Cast type indicator
Channel state information (CSI) request
Zone ID
Communication range requirement
Providing/Requesting indicator
Resource combinations
First resource location
Reference slot location
Resource set type
Lowest subChannel indices
Priority
Number of subchannels
Resource reservation period
Resource selection window location
Resource set type
Padding bits

In addition, in operation 923, the receiving terminal 902 transmits, to the transmitting terminal 901, information indicating whether demodulation/decoding of the data received in operation 921 is successful, through first HARQ feedback information. Here, the first HARQ feedback information includes acknowledgment (ACK) (success) or negative acknowledgement (NACK) (failure) information, and the receiving terminal 902 transfers the first HARQ feedback information to the transmitting terminal 901 via a PSFCH channel. In operation 925, the transmitting terminal 901 transmits the transmission result, as a second HARQ feedback information, to the base station 903 based on the first HARQ feedback information received from the receiving terminal 902. The second HARQ feedback is transmitted to the base station via PUCCH. In this case, the second HARQ feedback information may or may not be the same as the first HARQ feedback information. Further, the second HARQ feedback information may include multiple pieces of first HARQ feedback information. The multiple pieces of first HARQ feedback information may include multiple pieces of HARQ feedback information received from a single receiving terminal, or may include one or more HARQ feedback information received from multiple terminals. The second HARQ feedback information may enable the base station to allocate resources to the transmitting terminal 901 for retransmission, allocate resources for a new transmission, or stop allocating resources to the transmitting terminal 901 when there are no more transmission resources to be allocated to the transmitting terminal 901. The PUCCH transmission resources may be determined by DCI information that the base station transmits to the transmitting terminal in the PDCCH. The PSFCH transmission resource may be determined by the SCI of the PSCCH or may be determined by the transmission resource area in which the PSSCH is transmitted or received, in operation 923.

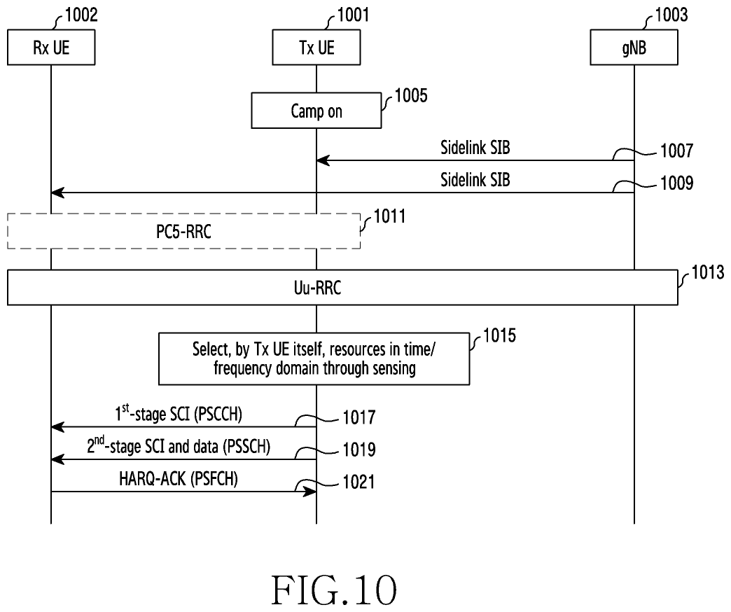

FIG. 10 illustrates a signal flow of allocating sidelink transmission resources in a wireless communication system according to an embodiment of the disclosure.

Referring to FIG. 10, it exemplifies signal exchange between a transmitting terminal 1001, a receiving terminal 1002, and a base station 1003.

As described below, a method in which the transmitting terminal 1001 directly allocates sidelink transmission resources through sensing in the sidelink may be referred to as mode 2. Mode 2 may also be referred to as UE autonomous resource selection. Specifically, according to mode 2, the base station 1003 may transmit a pool of sidelink transmission/reception resources for the sidelink to the terminal as system information or an RRC message (e.g., an RRC reconfiguration message, a PC5 RRC message), and the transmitting terminal 1001 may select a resource pool and a resource according to a predetermined rule. Unlike mode 1 described in FIG. 9, in which the base station 1003 is directly involved in resource allocation, mode 2 described in FIG. 10 may allow the transmitting terminal 1001 to autonomously select resources and transmit data, based on a resource pool that has been previously received through system information.

Referring to FIG. 10, the transmitting terminal 1001 camping on (operation 1005) may receive a sidelink SIB from the base station 1003 in operation 1007. In operation 1009, the receiving terminal 1002 may receive a sidelink SIB from the base station 1003. Here, the receiving terminal 1002 refers to a terminal that receives data transmitted by the transmitting terminal 1001. The sidelink SIB may be transmitted periodically or when requested (on demand). In addition, the sidelink SIB information may include at least one of sidelink resource pool information for sidelink communication, parameter configuration information for a sensing operation, information for configuring sidelink synchronization, or carrier information for sidelink communication operating at different frequencies. Operations 1007 and 1009 have been described as being performed sequentially above, but this is for convenience of explanation, and operations 1007 and 1009 may be performed in parallel.

In the case of FIG. 9 described above, the base station 1003 and the transmitting terminal 1001 operate in a state in which the RRC is connected, whereas in FIG. 10, the base station 1003 and the transmitting terminal 1001 may operate regardless of whether RRC between the base station 1003 and the transmitting terminal 1001 is connected in operation 1013. In other words, the base station 1003 and the transmitting terminal 1001 may perform mode-2 based sidelink communication in an idle or inactive mode in which RRC is not connected. In addition, even in a state in which RRC is connected, the base station 1003 may operate such that the transmitting terminal 1001 autonomously selects a transmission resource without being directly involved in resource allocation. In this case, the RRC connection between the transmitting terminal 1001 and the base station 1003 may be referred to as Uu-RRC.

In operation 1015, when data traffic for sidelink communication is generated by the transmitting terminal 1001, the transmitting terminal 1001 may be configured with a resource pool through system information received from the base station 1003, and may directly select time- and frequency-domain resources through sensing within the configured resource pool.

When unicast transmission and groupcast transmission are performed between the transmitting terminal 1001 and the receiving terminal 1002, the transmitting terminal 1001 may establish a one-to-one RRC connection with other terminals (e.g., the receiving terminal 1002) in operation 1011. In this case, the RRC connection between the transmitting terminal 1001 and the receiving terminal 1002 may be referred to as PC5-RRC in order to distinguish the same from Uu-RRC. In the case of the groupcast transmission method, PC5-RRC connection is individually established between terminals in the group. In FIG. 10, the PC5-RRC connection (operation 1011) is shown as an operation after transmission of the sidelink SIB (operation 1007, operation 1009), but the PC5-RRC connection (operation 1011) may be performed before transmission of the sidelink SIB or before transmission of the SCI (operation 1017). If the RRC connection between the terminals is required, the PC5-RRC connection of the sidelink may be performed, and in operation 1017, the transmitting terminal 1001 may transmit the SCI to the receiving terminal 1002 through the PSCCH by unicast or groupcast. At this time, groupcast transmission of SCI may be understood as group SCI. In addition, in operation 1019, the transmitting terminal 1001 may transmit data to the receiving terminal 1002 through the PSSCH through unicast or groupcast. When broadcast transmission is performed between the transmitting terminal 1001 and the receiving terminal 1002, the transmitting terminal 1001 may broadcast the SCI to the receiving terminal 1002 through the PSCCH without additional PC5-RRC configuration (operation 1011) in operation 1017. Further, in operation 1019, the transmitting terminal 1001 may broadcast data to the receiving terminal 1002 through the PSSCH.

In the case of mode 2, the transmitting terminal 1001 may directly perform sidelink scheduling by performing sensing and transmission resource selection operations. The first-stage SCI and second-stage SCI used in operations 1017 and 1019 may be as shown in the example of FIG. 9.

In addition, in operation 1021, the receiving terminal 1002 transmits information indicating whether the demodulation/decoding of the data received in operations 1017 and 1019 is successful, to the transmitting terminal 1001 through HARQ feedback information. Here, the HARQ feedback information includes ACK (success) or NACK (failure) information, and the receiving terminal 1002 transfers HARQ feedback information to the transmitting terminal 1001 via the PSFCH channel.

Further, although not shown in FIG. 9 or 10, if any transmitting terminal 1001 performs sidelink communication in OOC, mode 2 resource allocation may be used, and the information for sidelink communication that is usable may be information stored in the terminal through pre-configuration or may be configuration information received from the base station through sidelink relay.

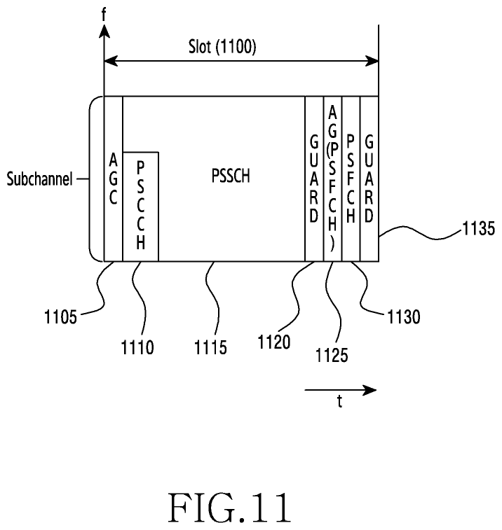

FIG. 11 illustrates a channel structure of a slot used for sidelink communication in a wireless communication system according to an embodiment of the disclosure.

FIG. 11 exemplifies physical channels mapped to slots for sidelink communication.

Referring to FIG. 11, an automatic gain control (AGC) 1105 that can be used by the receiving terminal is mapped to a first symbol of a slot 1100. Thereafter, a PSCCH 1110, a PSSCH 1115, a GUARD 1120, an AGC 1125 for PSFCH, a PSFCH 1130, and a GUARD 1135 may be mapped sequentially.

Before transmitting the PSCCH in the slot 1100, the transmitting terminal may transmit, in one or more symbols, a signal for AGC use having the same information as that of a symbol in which PSCCH (1110) is transmitted. The AGC symbol 1105 may be used to enable the receiving terminal to correctly perform automatic gain control (AGC) for adjusting the intensity of amplification when amplifying the power of the received signal. The signal for AGC may be referred to as a “sync signal”, a “sidelink sync signal”, a “sidelink reference signal”, a “midamble”, an “initial signal”, a “wake-up signal”, or using another term having an equivalent technical meaning.

The PSCCH 1110 including control information may be transmitted using symbols transmitted at the beginning of the slot, and the PSSCH 1115 scheduled by the control information of the PSCCH 1110 may be transmitted. At least a part of SCI, which is control information, may be mapped to the PSSCH 1115. Thereafter, the GUARD 1120 and the AGC 1125 for PSFCH exist, and the PSFCH 1130, which is a physical channel for transmitting feedback information, may be mapped.

In the case illustrated in FIG. 11, the PSFCH 1130 is located at the second symbol from the rear end of the slot. A terminal that has transmitted or received the PSSCH 1115 may prepare (e.g., transmission/reception switching) to transmit or receive the PSFCH 1130 by securing the GUARD 1120, which is a predetermined duration of unoccupied time between the PSSCH 1115 and the PSFCH 1130. Additionally, the AGC 1125 for the PSFCH 1130 may exist. After the PSFCH 1130, the GUARD 1135, which is a predetermined duration of unoccupied time, may exist.

The terminal may receive configuration of the position of a slot capable of transmitting the PSFCH 1130 in advance. Receiving the position of a slot in advance may signify that the position of a slot may be determined in advance during the process of producing the terminal, or may be transmitted to the terminal when the terminal accesses a system related to sidelink, or may be transmitted from the base station to the terminal when the terminal accesses the base station, or may signify a procedure in which the terminal receives from another terminal.

In the embodiment of FIG. 11, it has been described that a preamble signal for performing AGC is separately transmitted in a physical channel structure in a sidelink slot. However, according to another embodiment of the disclosure, there is no separate preamble signal transmission, and while receiving control information or a physical channel for data transmission, it is possible for the receiver of the receiving terminal to perform an AGC operation by using a control degree or a physical channel for data transmission.

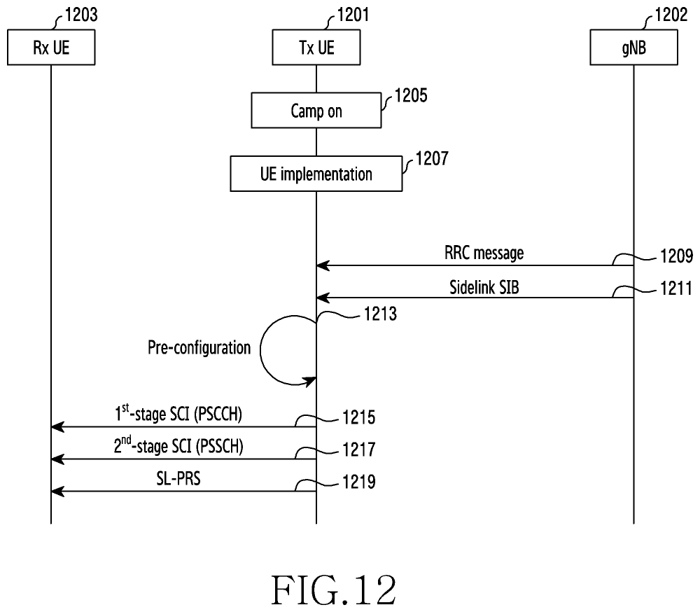

FIG. 12 illustrates a signal flow of configuring a priority of sidelink positioning reference signals in a wireless communication system according to an embodiment of the disclosure.

FIG. 12 illustrates signal exchange among a transmitting terminal (Tx UE) 1201, a receiving terminal (Rx UE) 1203, and a base station 1202.

Referring to FIG. 12, in operation 1205, the Tx UE 1201 may configure the priority of SCI 1215 for scheduling transmission resources of SL-PRS to a fixed value (e.g., a value greater than or equal to 1 and less than or equal to 8). This may have the effect of reducing signaling overhead with another layer or a base station.

In operation 1207, a value (e.g., a value greater than or equal to 1 and less than or equal to 8) of the priority of the SCI 1215 for scheduling transmission resources of the SL-PRS may be selected randomly by the Tx UE 1201 (UE implementation). This value may also be indicated to an AS layer by a higher layer (e.g., ranging & sidelink positioning protocol, LTE (NR) positioning protocol, sidelink LTE (NR) positioning protocol, or the like) that indicates or manages the SL-PRS transmission (operation 1219) of the Tx UE 1201. In such cases, the signaling overhead with the base station 1202 may be reduced.

In operations 1209 and 1211, the base station 1202 may transmit, through an RRC message (e.g., RRCReconfiguration), the value of the priority that the Tx UE 1201 in an RRC connected state uses or available for SL-PRS transmission (operation 1219). The Tx UE 1201 in an idle or inactive mode with no RRC connection may obtain the value of the priority used or available for SL-PRS transmission (operation 1219) via the sidelink SIB 1211 (e.g., SIB12). In the case of an OOC in which the Tx UE 1201 is out of the communication range of the base station 1202, a value of the priority that is used or available for the SL-PRS transmission (operation 1219) that has been preconfigured (operation 1213) may be acquired. The priority obtained in this manner may be included in a priority field of the SCI 1215 for scheduling transmission resources of the SL-PRS. The priority of the SL-PRS indicated by the base station 1202 may be indicated by a specific value, a list of specific values, or a value greater than or equal to 1 and less than or equal to 8 in the form of a bitmap such that the value is available if a bit is 1 and the value is unavailable if a bit is 0, and may be expressed by option 1 to option 3 of the examples in Table 1. This value may be configured per frequency information (e.g., SL-FreqConfig, SL-FreqConfigCommon) or per BWP (SL-BWP-Config, SL-BWP-ConfigCommon). Furthermore, this value may be a value allowed or used for SL-PRS transmission 1219 by the Tx UE 1201 regardless of a resource pool, and the values indicated by the RRC message (operation 1209), the sidelink SIB 1211, and the pre-configuration (operation 1213) may be the same or different from each other.

TABLE 1

| | |
|---|---|
| SL-PRS-Config ::= | SEQUENCE { |
| (option 1) sl-PriorityPRS | INTEGER (1..8) |
| (option 2) sl- | SEQUENCE (SIZE (1..maxNrofSL- |
| PriorityPRSList | PRS)) |

OF SL-PriorityPRS

| | |
|---|---|
| (option 3) sl-PriorityPRS | BIT STRING (SIZE (8)) |

...}

In the embodiment of FIG. 12, the base station 1202 may indicate the priority of the SL-PRS to the Tx UE 1201 through the RRC message 1209, the sidelink SIB 1211, and the pre-configuration 1213, the priority of the SL-PRS may be indicated by a specific value, a list of specific values, or a value greater than or equal to 1 and less than or equal to 8 in the form of a bitmap such that the value is available if a bit is 1 and the value is unavailable if a bit is 0, and may be expressed as shown in the example of Table 1. This value may be configured differently for each resource pool. The resource pool for the SL-PRS transmission (operation 1219) may be a shared resource pool that can be shared and used with other services (e.g., sidelink communication, sidelink relay, power saving, exceptional), or a dedicated resource pool that can be used by dedicating the SL-PRS transmission (operation 1219). This operation may be performed to use a structure different than the existing slot structure (e.g., FIG. 11) in the designated resource pool for SL-PRS transmission (operation 1219) in order to transmit SL-PRS (operation 1219) more efficiently. To configure the priority of SL-PRS per shared resource pool, the shared resource pool may include the sl-PRS-Config of Table 1, which includes the priorities of PRS, along with configurations for other services, as shown in the example of Table 2. The designated resource pool may include the content of SL-PRS-Config Table 1 along with other configurations specific to the configuration of the SL-PRS.

TABLE 2

| | |
|---|---|
| SL-ResourcePool ::= | SEQUENCE { |
| sl-PSCCH-Config | SetupRelease { SL-PSCCH-Config } |
| sl-PSSCH-Config | SetupRelease { SL-PSSCH-Config } |
| sl-PSFCH-Config | SetupRelease { SL-PSFCH-Config } |
| sl-PTRS-Config | SL-PTRS-Config |
| sl-PRS-Config | SL-PRS-Config |

...}

The designated resource pool is a pool where the SL-PRS transmission 1219 is not shared with other services, and may be divided into resource pools using scheme 1 where the base station designates the SL-PRS transmission resources and scheme 2 where the UE selects the SL-PRS transmission resources. The designated resource pool may represent a designated transmission pool and a designated reception pool to distinguish the same from other resource pools, as shown in the example of Table 3.

TABLE 3

| | |
|---|---|
| SL-BWP-PRSPoolConfig- | SEQUENCE { |
| r18 ::= | |

```
    sl-PRSRxPool-r18 SEQUENCE (SIZE (1..maxNrofRXPool-r16))
    OF SL-
ResourcePool-r16
```

| | |
|---|---|
| sl-PRSTxPoolSelected-r18 | SL-TxPoolDedicated-r16 |
| sl-PRSTxPoolScheduling-r18 | SL-TxPoolDedicated-r16 |

}

In operations 1215 and 1217, when the SL-PRS priority of a specific value is configured to be used, the Tx UE 1201 may include the value in the priority of the SCI for scheduling SL-PRS transmission resources and transmit the same to at least one Rx UE 1203 by unicast, groupcast, or broadcast. If multiple values of SL-PRS priority are configured to be used or indicated as allowed, a value (e.g., a value greater than or equal to 1 and less than or equal to 8) of the priority in the SCI 1215 for scheduling transmission resources for SL-PRS from among the multiple values configured or indicated may be selected either randomly by the Tx UE 1201 (UE implementation) or by the higher layer indicating or managing the SL-PRS transmission of the Tx UE (operation 1219).

In the embodiment of FIG. 12, if there is no configuration of the RRC parameter indicating that the SL-PRS priority is configured to be used or indicated as allowed, a value (e.g., a value greater than or equal to 1 and less than or equal to 8) for the priority in the SCI (operation 1215) for scheduling the transmission resources for SL-PRS may be selected randomly by the Tx UE 1201 (UE implementation). This value may be indicated by a higher layer that indicates or manages the SL-PRS transmission (operation 1219) of the transmitting terminal (Tx UE).

In the embodiment of FIG. 12, the SCI for scheduling the transmission resources of the SL-PRS may use the 1st-stage SCI in operation 1215, as in the example of FIG. 9, the SCI format 1-A as in the example of FIG. 9 may be used for compatibility when utilizing the same resource pool as other services, and the 2nd-stage SCI in operation 1219 may use a format specialized for SL-PRS transmission. Further, in the case of a dedicated resource pool for transmission of SL-PRS, only the 1st-stage SCI (operation 1215) having a format different from SCI format 1-A may be used, and the 2nd-stage SCI (operation 1217) may not be used. This operation may be performed to use a structure different than the existing slot structure (e.g., FIG. 11) in the designated resource pool for the transmission of the SL-PRS (operation 1219) in order to more efficiently transmit the SL-PRS. Even if the new format of 1st-stage SCI (operation 1215) is used, prioritization may be included for sensing resources occupied by other terminals and for selecting and reselecting resources used by the Tx UE 1201.

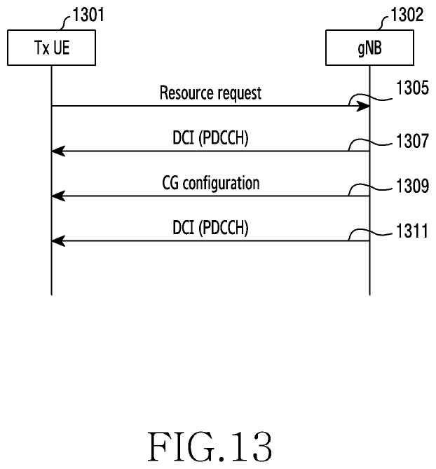

FIG. 13 illustrates a signal flow in which a base station indicates resources to be used for transmission of a sidelink positioning reference signal in a wireless communication system according to an embodiment of the disclosure.

Referring to FIG. 13, in operation 1305, when a base station 1302 is using scheme 1 for designating SL-PRS transmission resources (or mode 1 in the case of sharing a resource pool by other services), the base station may allocate resources for SL-PRS transmission to a Tx UE 1301 in a DG and CG scheme, as described in FIG. 9. In the case of DG scheme, the Tx UE 1301 may request SL-PRS transmission resources from the base station 1302 as shown in the example of FIG. 9. When a PUCCH is used, the base station 1302 may inform the Tx UE 1301 of the period, uplink time, and frequency resources of the PUCCH to transmit the SR for the SL-PRS transmission resource request through an RRC message (e.g., RRCReconfiguration). In this case, multiple SR transmission resources may be configured and each SR transmission may be configured to have one or more SL-PRS priorities. In an embodiment of the disclosure, the SR transmission resource for requesting the transmission resources of the SL-PRS of priority 1 may be different from the SR transmission resource for requesting the transmission resources of the SL-PRS of priority 2, and the SR transmission resources for requesting the transmission resources of the SL-PRS of priority 3 and 4 may be the same. For this configuration, the ID of each SR resource may be combined with the form of Table 1 above.

When MAC CEs are used, the SL-PRS may use MAC CEs that request a new type of SL-PRS resources instead of using the existing sidelink BSRs because the SL-PRS has no data size. The MAC CE may include an SL-PRS priority. The SL-PRS priority having a length of 3 bits may request transmission resources for the SL-PRS having the corresponding priority. The logical channel priority of the MAC CE for requesting SL-PRS resources may be the same as the priority of the SL-PRS to be transmitted, or may be the same as the priority included in the MAC CE.

Further, the logical channel priority of the MAC CE for requesting the SL-PRS resource may have a fixed value configured by the base station 1302. If the base station 1302 does not configure the logical channel priority of the MAC CE for requesting SL-PRS resources, the logical channel priority of the MAC CE for requesting SL-PRS resources may be the same as the priority of the SL-PRS to be transmitted, or may be the same as the priority included in the MAC CE. The MAC CE for requesting SL-PRS resources may be prioritized in the same method as that of the SL-BSR MAC CE, and may be included in a padding bit. When the SL-BSR MAC CE and the SL-PRS resource request MAC CE having the same priority are unable to be transmitted simultaneously, either the SL-BSR MAC CE or the SL-PRS resource request MAC CE may have a higher priority, and one of the SL-BSR MAC CE and the SL-PRS resource request MAC CE may be selected (e.g., an MAC CE, which requires faster transmission to satisfy QoS, may be first selected) randomly by a UE (UE implementation). When requesting resources from the base station 1302 through RRC messages, the Tx UE 1301 may inform the base station 1302 of information for SL-PRS transmission through RRC messages (e.g., SidelinkUEInformationNR, UEAssistanceInformation). The Tx UE 1301 may include QoS-related information or requirements of the sidelink positioning (e.g., horizontal accuracy, vertical accuracy, response time, mobility, or the like) in the RRC message, and a value obtained by mapping these requirements to a single value may be used. Further, a value to which such QoS-related information or requirements of the sidelink positioning are mapped may be a sidelink standardized qos identifier (SL-PQI). In another embodiment of the disclosure, the Tx UE 1301 may include in the RRC message 1305 the value of at least one priority used for SL-PRS transmission, which may be indicated by a single value, a list, or a bitmap, such as option 1 to option 3 of the examples in Table 4.

TABLE 4

| | |
|---|---|
| (option 1) sl-PriorityPRS | INTEGER (1..8) |
| (option 2) sl-PriorityPRSList | SEQUENCE (SIZE (1..maxNrofSL- |

PRS)) OF SL-PriorityPRS

| | |
|---|---|
| (option 3) sl-PriorityPRS | BIT STRING (SIZE (8)) |

In operation 1307, the base station 1302 may use DCI to allocate SL-PRS transmission resources to the Tx UE 1301. The base station 1302 may indicate SL-PRS transmission resources, to the Tx UE 1301, by using the same DCI format as before (e.g., DCI format 3_0) or a new DCI format for SL-PRS scheduling. Here, the SL-PRS priority having a length of 3 bits, which is the priority to be used for transmission of the SL-PRS, may be included.

In operation 1309, for the CG, the base station 1302 may support a Type 1 CG where the base station 1302 informs the Tx UE 1301 of the transmission period, transmission resources, and transmission start time through RRC, and may support a Type 2 CG where the transmission period is informed through RRC but the transmission start time is informed through DCI. When the Type 1 CG is used, the base station 1302 may include, in the CG configuration, the priority used for SL-PRS transmitted in the corresponding CG, and the CG configuration may be indicated by a single value, a list, or a bitmap, as shown in the examples in Table 5. Options 1-1 to 1-3 are configurations for CG Type 1 or CG Type 2, and options 2-1 to 2-3 are configurations for CG Type 1. When a shared resource pool is used, these CG configuration may be included in the existing SL-ConfiguredGrantConfig. However, when a designated resource pool is used for SL-PRS transmission, a new CG configuration for SL-PRS may be introduced and include the priority of the SL-PRS, similar to the example in Table 5.

TABLE 5

| | |
|---|---|
| SL-ConfiguredGrantConfig-r16 ::= | SEQUENCE { |
| sl-ConfigIndexCG-r16 | SL-ConfigIndexCG-r16, |
| (option 1-1) sl-PriorityPRS | INTEGER (1..8) |
| (option 1-2) sl-PriorityPRSList | SEQUENCE (SIZE |
| | (1..maxNrofSL- |

PRS)) OF SL-PriorityPRS

| | |
|---|---|
| (option 1-3) sl-PriorityPRS | BIT STRING (SIZE (8)) |

...,

| | |
|---|---|
| rrc-ConfiguredSidelinkGrant-r16 | SEQUENCE { |
| (option 2-1) sl-PriorityPRS | INTEGER (1..8) |
| (option 2-2) sl- | SEQUENCE (SIZE |
| PriorityPRSList | |

(1..maxNrofSL-PRS)) OF SL-PriorityPRS

| | |
|---|---|
| (option 2-3) sl-PriorityPRS | BIT STRING (SIZE (8)) |

```
    } ...,
  }
```

In the case of Type 2 CG, CG activation using DCI (operation 1311) may be required and, if prioritization is not included in the CG configuration (operation 1309), the prioritization may be included in DCI (operation 1311) and transmitted, as in the DG scheme. In such a case, the Tx UE 1301 may determine the priority of the SL-PRS, which is transmitted by the Type 2 CG and activated by the DCI (operation 1311), as a value configured by the DCI (operation 1311).

If the base station 1302 does not include a priority in the DCI (operation 1307, 1311) or CG configuration (operation 1309), the UE may configure the priority of the transmitting SL-PRS as a fixed value (e.g., a value greater than or equal to 1 and less than or equal to 8). In addition, when the base station 1302 does not include a priority in the DCI (operation 1307, 1311) or CG configuration (operation 1309) and, if the value of SL-PRS priority is configured as allowed values for each frequency, BWP, or resource pool as shown in the example in FIG. 12, one of the allowed values may be selected randomly by the UE (UE implementation), and this value may be indicated to AS layer by a higher layer.

In the embodiment of FIG. 13, the resource request (operation 1305), the DCI for DG (operation 1307), and the DCI for CG configuration and activation (operation 1309, 1311) are illustrated sequentially, but this is for illustrative purposes only and the order may vary based on the implementation of the scheduling operation sequence of the base station.

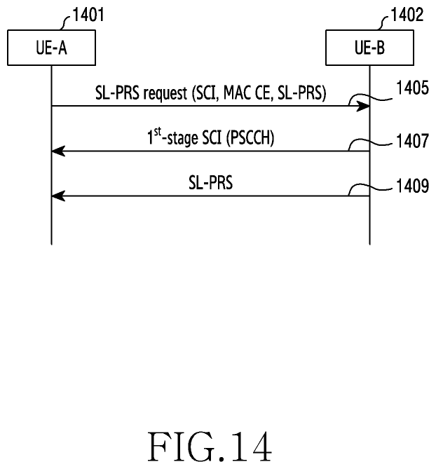

FIG. 14 illustrates a signal flow of requesting a sidelink positioning reference signal from another terminal in a wireless communication system according to an embodiment of the disclosure.

Referring to FIG. 14, a UE-A 1401 may request an SL-PRS from a UE-B 1402. Through such a request, the UE-A 1401 may use positioning technique based on a round trip time (RTT) of transmitting and receiving the SL-PRS to and from the UE-B 1402 or a result of measurement of the SL-PRS by the UE-B 1402. In addition, a fast response may be expected in a state in which information exchange at a higher layer has already taken place.

In operation 1405, the SL-PRS request may be made from the UE-A 1401 through SCI, MAC CE, and SL-PRS. If the SL-PRS request is made through SCI, the SCI may include a bit indicative of requesting the SL-PRS. If the SL-PRS request is made through the MAC CE, the corresponding MAC CE may be distinguished by a logical channel identifier (LCID) indicating the MAC CE for requesting the SL-PRS, and may include, in the form of 3 bits, a priority (e.g., a value of at least 1 and no more than 8) of the SL-PRS requested in operation 1409.

In the embodiment of FIG. 14, if the SL-PRS is requested through the SCI or SL-PRS, the priority may be included in the SCI. This priority may be the priority of the SL-PRS scheduled by the corresponding SCI, as in the examples of FIGS. 12 and 13, and may require determination of the priority if the UE-A 1401 makes a request for the SL-PRS from the UE-B 1402 instead of transmitting the SL-PRS. Further, when the priority of the transmitting SL-PRS and the requested priority of the SL-PRS are different, the SCI may prioritize the higher one of the two priorities (e.g., a value close to 1 where 1 is the highest priority and 8 is the lowest priority). The priority included in the SCI for requesting the SL-PRS may be a fixed value greater than or equal to 1 and less than or equal to 8, or value may be selected randomly by the UE (UE implementation) or may be indicated through the higher layer. The base station or network may configure, in the UE-A 1401 the value of the priority through an RRC message (e.g., RRCReconfiguration, sidelink SIB) or pre-configuration, and may configure the value of the priority in the form of a single value, a list, or a bitmap, such as option 1 to option 3 of the examples in Table 6. Further, the value may be configured per frequency, BWP, or resource pool, and the method of configuring the value may be the same as the configuration method described in the embodiment of FIG. 12. If multiple values of SL-PRS requests are configured to be used or indicated as allowed, a value (e.g., a value greater than or equal to 1 and less than or equal to 8) of the prioritization of the SCI for requesting the SL-PRS may be selected randomly by the UE-A 1401 (UE implementation) from among the multiple values configured or indicated, or may be selected by the higher layer indicating or managing the SL-PRS requests of the UE-A 1401. If the priority used by the UE-A 1401 to request SL-PRS is not configured, the priority included in the SCI for requesting the SL-PRS may be configured to be a fixed value, which is greater than or equal to 1 and less than or equal to 8, or a value may be selected randomly by the UE (UE implementation), or may be selected by the higher layer indicating or managing the SL-PRS request.

TABLE 6

| | |
|---|---|
| (option 1) sl-PriorityPRSRequest | INTEGER (1..8) |
| (option 2) sl-PriorityPRSRequestList | SEQUENCE (SIZE |

(1..maxNrofSL-PRS)) OF SL-PriorityPRS

| | |
|---|---|
| (option 3) sl-PriorityPRSRequest | BIT STRING (SIZE (8)) |

In the embodiment of FIG. 14, when requesting the SL-PRS through the MAC CE, SCI that schedules a TB including the corresponding MAC CE may have the highest value among the priorities of all logical channels or MAC CEs included in the TB. Additionally, the logical channel priority of the SL-PRS requesting MAC CE may have a fixed value (e.g., 1) and the corresponding value may be included in the SCI, or the value of the priority included in the SCI through configuration, such as the examples in Table 6 may be different from the logical channel priority. Further, the value may be configured for each frequency, BWP, or resource pool, and the configuration method thereof may be the same as the configuration method described in the embodiment of FIG. 12.

In operations 1407 and 1409, upon receiving the SL-PRS request from the UE-A 1401, the UE-B 1402 may determine the priority of the SL-PRS to be transmitted to the UE-A 1401 and include the same in the SCI. Thereafter, the UE-B 1402 may transmit the SL-PRS and the SCI including the SL-PRS priority determined by the UE-A 1401. The priority of the SL-PRS may use a fixed value as shown in the examples of FIGS. 12 and 13, a value selected randomly (UE implementation) by the UE-B 1402, or a value indicated by the base station. The SL-PRS priority of FIGS. 12 and 13 may be different from the priority of the SL-PRS transmitted in response to the SL-PRS request, and may be configured in the form of a single value, a list, or a bitmap, such as option 1 to option 3 of the examples in Table 7, and may be distinguished by different IEs.

TABLE 7

| | |
|---|---|
| (option 1) sl-PriorityPRSResponse | INTEGER (1..8) |
| (option 2) sl-PriorityPRSResponseList | SEQUENCE (SIZE |

(1..maxNrofSL-PRS)) OF SL-PriorityPRS

| | |
|---|---|
| (option 3) sl-PriorityPRSResponse | BIT STRING (SIZE (8)) |

When the SL-PRS priority in response to the SL-PRS request is not configured in UE-B 1402, the UE-B 1402 may use, as the priority of the SL-PRS, the same value as the priority included in the SCI used for the SL-PRS request transmitted by the UE-A 1401. If the MAC CE is used and the priority of the requesting SL-PRS is included in the MAC CE, the UE-B 1402 may use, as the priority of the SL-PRS, the same value as the priority requested by the MAC CE transmitted by the UE-A 1401.

The UE-B 1402 may include the determined SL-PRS priority as a priority in the SCI for scheduling the corresponding SL-PRS.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including random access memory and flash memory, read only memory (ROM), electrically erasable programmable read only memory (EEPROM), magnetic disc storage device, compact disc-ROM (CD-ROM), digital versatile discs (DVDs), or other type optical storage devices, or a magnetic cassette. Alternatively, any combination of some or all of them may form memory in which the program is stored. Furthermore, a plurality of such memories may be included in the electronic device.

In addition, the programs may be stored in an attachable storage device which may access the electronic device through communication networks, such as the Internet, intranet, local area network (LAN), wide LAN (WLAN), and storage area network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first user equipment (UE) in a wireless communication system, the method comprising:
identifying a priority of a sidelink (SL) positioning reference signal (PRS) indicated by a higher layer;
transmitting, to a second UE, sidelink control information (SCI) for scheduling the SL PRS, the SCI including first information on the priority of the SL PRS; and
transmitting, to the second UE, the SL PRS.

2. The method of claim 1, wherein the priority of the SL PRS is one of 8 values.

3. The method of claim 1,
wherein the SCI is for a dedicated SL PRS resource pool, and
wherein a size of the first information included in the SCI is 3 bits.

4. The method of claim 1, further comprising:
transmitting, to a base station (BS), a medium access control (MAC) control element (CE) requesting a resource for the SL PRS, the MAC CE including second information on the priority of the SL PRS,
wherein a size of the second information included in the MAC CE is 3 bits.

5. The method of claim 1, further comprising:
transmitting, to the BS, a radio resource control (RRC) message requesting a resource for the SL PRS, the RRC message including third information on the priority of the SL PRS,
wherein a size of the third information included in the RRC message is 3 bits.

6. A method performed by a second user equipment (UE) in a wireless communication system, the method comprising:
receiving, from a first UE, sidelink control information (SCI) for scheduling a sidelink (SL) positioning reference signal (PRS), the SCI including first information on a priority of the SL PRS;
receiving, from the first UE, SL PRS; and
identifying position of the first UE, based on the SCI and the SL PRS,
wherein the priority of the SL PRS is identified as indicated by a higher layer of the first UE.

7. The method of claim 6, wherein the priority of the SL PRS is one of 8 values.

8. The method of claim 6,
wherein the SCI is for a dedicated SL PRS resource pool, and
wherein a size of the first information included in the SCI is 3 bits.

9. A first user equipment (UE) in a wireless communication system, the UE comprising:
a transceiver; and
a controller coupled with the transceiver and configured to:
identify a priority of a sidelink (SL) positioning reference signal (PRS) indicated by a higher layer,
transmit, to a second UE, sidelink control information (SCI) for scheduling the SL PRS, the SCI including first information on the priority of the SL PRS, and
transmit, to the second UE, the SL PRS.

10. The first UE of claim 9, wherein the priority of the SL PRS is one of 8 values.

11. The first UE of claim 9,
wherein the SCI is for a dedicated SL PRS resource pool, and
wherein a size of the first information included in the SCI is 3 bits.

12. The first UE of claim 9,
wherein the controller is further configured to:
transmit, to a base station (BS), a medium access control (MAC) control element (CE) requesting a resource for the SL PRS, the MAC CE including second information on the priority of the SL PRS, and
wherein a size of the second information included in the MAC CE is 3 bits.

13. The first UE of claim 9,
wherein the controller is further configured to:
transmit, to the BS, a radio resource control (RRC) message requesting a resource for the SL PRS, the RRC message including third information on the priority of the SL PRS, and
wherein a size of the third information included in the RRC message is 3 bits.

14. A second user equipment (UE) in a wireless communication system, the UE comprising:
a transceiver; and
a controller coupled with the transceiver and configured to:
receive, from a first UE, sidelink control information (SCI) for scheduling a sidelink (SL) positioning reference signal (PRS), the SCI including first information on a priority of the SL PRS,
receive, from the first UE, SL PRS, and
identify position of the first UE, based on the SCI and the SL PRS,
wherein the priority of the SL PRS is identified as indicated by a higher layer of the first UE.

15. The second UE of claim 14, wherein the priority of the SL PRS is one of 8 values.

16. The second UE of claim 14,
wherein the SCI is for a dedicated SL PRS resource pool, and
wherein a size of the first information included in the SCI is 3 bits.
